(19) United States
(12) Patent Application Publication
(10) Pub. No.: US 2026/0180824 A1
(43) Pub. Date: Jun. 25, 2026

(54) Peripheral Device Disaggregation using Tunneling

(71) Applicant: Mellanox Technologies, Ltd., Yokneam (IL)

(72) Inventors: Michael Kagan, Zichron Yaakov (IL); Diego Crupnicoff, Buenos Aires (AR); Yuval Shicht, Tel Aviv (IL); Daniel Marcovitch, Yokneam Illit (IL); Noam Bloch, Bat Shlomo (IL); Lior Narkis, Petah Tikva (IL)

(21) Appl. No.: 18/991,577

(22) Filed: Dec. 22, 2024

(51) Int. Cl. H04L 12/46; G06F 13/10; H04L 69/22

(52) U.S. Cl. CPC H04L 12/4633; G06F 13/105; H04L 69/22

(57) ABSTRACT

A system includes one or more processing devices, one or more peripheral devices, and an interconnection fabric to connect the one or more processing devices and the one or more peripheral devices. A plurality of pairs is set-up in the system, each pair including (i) a respective processing device among the one or more processing devices and (ii) a respective peripheral device among the one or more peripheral devices. Each pair is to communicate over a respective tunnel established via the interconnection fabric, so as to provide resources of the peripheral device to the processing device.

### TECHNICAL FIELD

The present disclosure relates generally to computing and communication systems, and particularly to methods and systems for peripheral device disaggregation.

### BACKGROUND

Computing and communication systems, such as data centers and High-Performance Computing (HPC) clusters, may employ disaggregation techniques to make efficient use of computation, networking and storage resources. Various disaggregation techniques have been proposed.

For example, in “Disaggregated Computing—An Evaluation of Current Trends for Datacentres,” Hugo Meyer et al., Procedia Computer Science 108C (2017 ), pages 685-694, the authors assert that next generation data centers will likely be based on the emerging paradigm of disaggregated function-blocks-as-a-unit departing from the current state of mainboard-as-a-unit. Multiple functional blocks or bricks such as compute, memory and peripheral will be spread through the entire system and interconnected together via one or multiple high-speed networks.

In “Scalable Resource Disaggregated Platform That Achieves Diverse and Various Computing Services,” NEC Technical Journal, Vol.9, No.2, Special Issue on Future Cloud Platforms for ICT Systems, by Takashi et al., the authors describe the future accommodation of a wide range of services by cloud data centers, which will require the ability to simultaneously handle multiple demands for data storage, networks, numerical analysis, and image processing from various users, and introduce a Resource Disaggregated Platform that will make it possible to perform computation by allocating devices from a resource pool at the device level and to scale up individual performance and functionality.

### SUMMARY

An embodiment that is described herein provides a system including one or more processing devices, one or more peripheral devices, and an interconnection fabric to connect the one or more processing devices and the one or more peripheral devices. A plurality of pairs is set-up in the system, each pair including (i) a respective processing device among the one or more processing devices and (ii) a respective peripheral device among the one or more peripheral devices. Each pair is to communicate over a respective tunnel established via the interconnection fabric, so as to provide resources of the peripheral device to the processing device.

In some embodiments, in a given pair, the peripheral device includes a network device, and the tunnel is established to provide networking resources of the network device to the processing device. In some embodiments, in a given pair, the peripheral device includes a storage device, and the tunnel is established to provide storage resources of the storage device to the processing device. In an embodiment, the system further includes a controller to set-up the pairs and the tunnels.

In a disclosed embodiment, the pairs include at least (i) a first pair including a given processing device and a first peripheral device, and (ii) a second pair including the given processing device and a second peripheral device. In an example embodiment, the pairs include at least (i) a first pair including a given peripheral device and a first processing device, and (ii) a second pair including the given peripheral device and a second processing device.

In an embodiment, the interconnection fabric operates in accordance with a fabric communication protocol that does not guarantee in-order delivery of data.

In some embodiments, for a given tunnel, the processing device and the peripheral device are provisioned with respective tunnel endpoint modules that (i) emulate a local peripheral bus protocol toward the processing device and the peripheral device, and (ii) communicate with one another over the interconnection fabric in accordance with a fabric communication protocol.

In an example embodiment, a tunnel endpoint module is to (i) receive packets of the peripheral bus protocol for transporting via the given tunnel (ii) encapsulate the packets of the peripheral bus protocol at least with network headers of the fabric communication protocol, and (iii) send the encapsulated packets via the given tunnel.

In another example embodiment, the packets of the peripheral bus protocol specify a destination address or destination identifier, and the tunnel endpoint module is to obtain a network address or network identifier associated with the destination address or destination identifier, and to insert the network address or network identifier in the network headers of the encapsulated packets.

In yet another embodiment, a tunnel endpoint module is to (i) receive, from the given tunnel, encapsulated packets of the fabric communication protocol that contain packets of the peripheral bus protocol, (ii) decapsulate the encapsulated packets to reproduce the packets of the peripheral bus protocol, and (iii) output the packets of the peripheral bus protocol.

In another embodiment, the tunnel endpoint modules are to implement end-to-end credit-based flow control with one another over the given tunnel. In an example embodiment, the peripheral bus protocol supports multiple transaction types, and the tunnel endpoint modules are to implement the end-to-end credit-based flow control independently for each of the transaction types of the peripheral bus protocol.

In still another embodiment, the peripheral bus protocol specifies one or more transaction ordering rules that govern an order of delivery of transactions, and the tunnel endpoint modules are to deliver the transactions of the peripheral bus protocol while complying with the transaction ordering rules.

In a disclosed embodiment, one of the tunnel endpoint modules is to distribute packets of the fabric communication protocol over multiple different paths via the interconnection fabric, and the other of the endpoint modules is to receive the packets from the multiple different paths, and reorder the received packets.

In an embodiment, one of the tunnel endpoint modules is to receive a packet of the peripheral bus protocol for transporting via the given tunnel, to fragment the packet into multiple packets of the fabric communication protocol, and to send the packets of the fabric communication protocol via the given tunnel, and the other of the endpoint modules is to receive the packets from the given tunnel, and reassemble the packet of the peripheral bus protocol from the multiple packets of the fabric communication protocol.

In another embodiment, one of the tunnel endpoint modules is to receive multiple packets of the peripheral bus protocol for transporting via the given tunnel, to coalesce the packets into a packet of the fabric communication protocol, and to send the packet of the fabric communication protocol via the given tunnel, and the other of the endpoint modules is to receive the coalesced packet from the given tunnel, and re-fragment the coalesced into the multiple packets of the peripheral bus protocol.

There is additionally provided, in accordance with an embodiment that is described herein, a method in a system that includes one or more processing devices and one or more peripheral devices connected by an interconnection fabric. The method includes setting up a plurality of pairs, each pair including (i) a respective processing device among the one or more processing devices and (ii) a respective peripheral device among the one or more peripheral devices. For each pair, resources of the respective peripheral device are provided to the respective processing device by communicating over a respective tunnel established via the interconnection fabric.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a computing and communication system that uses Network Interface Controller (NIC) disaggregation, in accordance with an embodiment that is described herein;

FIG. 2 is a flow chart that schematically illustrates a method for communicating between a host and a disaggregated NIC, in accordance with an embodiment that is described herein;

FIG. 3 is a diagram that schematically illustrates a PCIe Tunneling Protocol (PCTP) stack, in accordance with an embodiment that is described herein;

FIGS. 4A-4F are diagrams that schematically illustrate PCTP packet formats, in accordance with embodiments that are described herein;

FIGS. 5 and 6 are block diagrams that schematically illustrate address lookup operations in PCTP, in accordance with an embodiment that is described herein;

FIG. 7 is a block diagram that schematically illustrates end-to-end credit control over a PCIe tunnel, in accordance with an embodiment that is described herein;

FIG. 8 is a block diagram that schematically illustrates transaction ordering over a PCIe tunnel, in accordance with an embodiment that is described herein;

FIG. 9 is a block diagram that schematically illustrates an alternative reorder buffer implementation, in accordance with an embodiment that is described herein;

FIG. 10 is a block diagram that schematically illustrates another alternative reorder buffer implementation, in accordance with an embodiment that is described herein; and

FIG. 11 is a diagram that schematically illustrates a process of establishing a PCIe tunnel, in accordance with an embodiment that is described herein; and

FIG. 12 is a block diagram that schematically illustrates a computing system that uses network device disaggregation, in accordance with an embodiment that is described herein.

### DETAILED DESCRIPTION OF EMBODIMENTS

### Overview

Embodiments that are described herein provide improved methods and systems for peripheral device disaggregation. In the present context, the term “peripheral device disaggregation” refers to allocation of resources of one or more peripheral devices, for use by one or more processing devices. When using peripheral device disaggregation, there is no need for rigid assignment of peripheral devices to processing devices. Instead, partial resources of peripheral devices may be allocated flexibly to processing devices.

In various embodiments, peripheral devices may comprise, for example, network devices (e.g., Network Interface Controllers—NICs, Host Channel Adapters—HCAs and Data Processing units—DPUs, also known as “Smart NICs”), storage devices (e.g., Solid State Drives—SSDs), Graphics Processing Units (GPUs) or computational accelerators. Processing devices may comprise, for example, hosts, Central Processing Units (CPUs), GPUs or other processors. By way of non-limiting example, the embodiments described herein refer mainly to NIC disaggregation in a system that comprises one or more NICs and one or more hosts.

Consider an example system that includes multiple hosts and multiple NICs. The NICs are used for connecting the hosts to a network, e.g., an Ethernet or InfiniBand™ (IB) network. Each host is conventionally designed to communicate with a local NIC over a peripheral bus; and each NIC is conventionally designed to communicate with a local host over a peripheral bus. An example of a peripheral bus is Peripheral Component Interconnect express (PCIe).

In some embodiments, for introducing disaggregation, the hosts and NICs are not locally coupled to one another via a PCIe bus, but instead interconnected by an interconnection fabric. An example fabric is Nvlink. In order to allocate resources of a NIC to a host, a “tunnel” is established between the host and the NIC via the fabric. The hosts and the NICs comprise respective tunnel endpoint modules, also referred to as Tunnel Endpoints (TEPs). In a given tunnel that connects a host and a NIC, a pair of TEPs terminate the tunnel. In particular, the TEPs (i) emulate the peripheral bus protocol (e.g., PCIe) toward the NIC and host, and (ii) communicate with one another over the interconnection fabric using the fabric protocol (e.g., Nvlink).

When using the disclosed techniques, a host may access a network by communicating conventionally using PCIe. The TEP installed on the host presents the disaggregated resources of one or more NICs to the host as a conventional local NIC. The host applications are typically unaware of the disaggregation. Similarly, a NIC may serve one or more hosts by communicating conventionally using PCIe. The TEP installed on the NIC handles communication over the interconnection fabric, while hiding the disaggregation from the NIC. This solution provides the flexibility and performance benefits of disaggregation, while at the same time minimizing the changes needed in the hosts and NICs.

In some embodiments, the peripheral bus protocol (e.g., PCIe) has relatively strict transaction ordering rules, while the fabric communication protocol (e.g., Nvlink) may be more relaxed with respect to transaction ordering. In these embodiments, part of the TEP functionality is to ensure the transaction ordering rules of the peripheral bus protocol are met, while exploiting the performance benefits of the relaxed-order fabric protocol. The TEPs may also perform tasks such as credit control, multipathing (e.g., “spraying”), fragmentation and coalescing. Example implementations of these mechanisms are described in detail herein.

### System Description

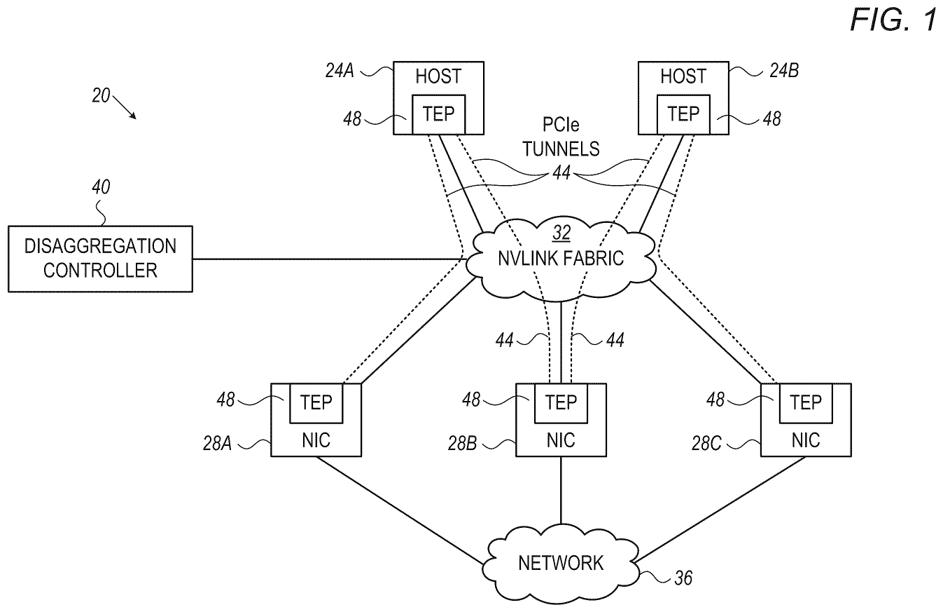

FIG. 1 is a block diagram that schematically illustrates a computing and communication system 20 that uses NIC disaggregation, in accordance with an embodiment that is described herein. System 20 may comprise, for example, a data center, an HPC cluster or any other suitable system.

System 20 comprises one or more hosts 24, in the present example two hosts denoted 24A and 24B, and one or more NICs 28, in the present example three NICs denoted 28A, 28B and 28C. The hosts and NICs are interconnected by an interconnection fabric 32, in the present example an Nvlink fabric. NICs 28 are used for connecting hosts 24 to a network 36, e.g., an Ethernet or IB network.

System 20 further comprises a disaggregation controller 40 that manages the disclosed tunneling-based NIC disaggregation. Among other tasks, controller 40 establishes multiple tunnels 44 via fabric 32. Each tunnel 44 connects a respective pair comprising a selected host 24 and a selected NIC 28.

Each tunnel 44 enables the selected host 24 to access network 36 using the networking resources of the selected NIC 28. The ends of each tunnel 44 are terminated by tunnel endpoint modules referred to as TEPs 48, one TEP running in the host at one end of the tunnel, and the other TEP running in the NIC at the other end of the tunnel. Controller 40 typically establishes and configures tunnels 44 by configuring TEPs 48 in the various hosts and NICs.

In an embodiment, when a certain host 24 uses multiple NICs 28, the TEP of the host terminates multiple tunnels. Similarly, when a certain NIC 28 serves multiple hosts 24, the TEP of the NIC terminates multiple tunnels. The system may also include one or more hosts or NICs that do not participate in the disaggregation scheme.

The configurations of system 20, hosts 24, NICs 28 and controller 40, as depicted in FIG. 1, are example configurations that are chosen purely for the sake of conceptual clarity. Any other suitable configurations can be used in alternative embodiments.

For example, the disclosed techniques can be used in various system configurations, e.g., systems including multiple processing devices (hosts or otherwise) and multiple peripheral devices (NICs or otherwise), systems including a single processing device and multiple peripheral devices, and systems including multiple processing devices and a single peripheral device.

As another example, the embodiments described herein refer mainly to emulation of PCIe by TEPs 48, enabling hosts 24 and NICs 28 to communicate with one another using PCIe with little or no change. In alternative embodiments, TEPs 48 may emulate any other suitable type of peripheral bus protocol, e.g., Compute Express Link (CXL). The disclosed techniques are also not limited to use with Nvlink fabrics. In alternative embodiments, fabric 32 may operate in accordance with any other suitable fabric protocol, and TEPs 48 may support any such protocol. Suitable protocols include, for example, Nvlink chip-to-chip (C2C).

Elements that are not mandatory for understanding of the disclosed techniques have been omitted from the figure for the sake of clarity. For example, each host 24 (or other processing device) typically comprises (i) one or more processors that carry out various computing tasks including running TEP 48, and (ii) an interface (e.g., PCIe interface) for communicating over fabric 32. Each NIC 28 (or other peripheral device) typically comprises (i) one or more processors and/or other circuitry that implement various processing tasks, including TEP 48, and (ii) a host interface (e.g., PCIe interface) for communicating over fabric 32. Controller 40, too, typically comprises (i) one or more processors that carry out the various computing tasks of the controller, and (ii) an interface for communicating over fabric 32, e.g., with the various TEPs 48. In some embodiments, controller 40 is not implemented as a separate computer, but rather embedded in a processor of one of hosts 24, in an additional NIC 28 or GPU connected to a host 24, etc.

In various embodiments, the various elements of system 20, including hosts 24 (or other processing devices), NICs 28 (or other peripheral devices) and controller 40, may be implemented using suitable software, using suitable hardware such as one or more Application-Specific Integrated Circuits (ASIC) or Field-Programmable Gate Arrays (FPGA), or using a combination of hardware and software. Some system elements, e.g., controller 40 and/or TEP 48, may be implemented using one more general-purpose processors, which are programmed in software to carry out the techniques described herein. The software may be downloaded to any of the processors in electronic form, over a network, for example, or it may, alternatively or additionally, be provided and/or stored on non-transitory tangible media, such as magnetic, optical, or electronic memory.

### Peripheral Device Disaggregation Using Tunneling

In some embodiments, disaggregation controller 40 defines multiple {host 24, NIC 28} pairs in system 20. Controller 40 establishes a respective tunnel 44 between the host and the NIC of each pair, by provisioning TEPs 48 in the host and NIC. A given TEP 48 is responsible for both ingress processing (processing of traffic exiting the tunnel, from fabric 32 to the host or NIC) and egress processing (processing of traffic entering the tunnel, from the host or NIC to fabric 32).

In practice, the peripheral bus protocol used by hosts and NICs 28 (in the present example PCIe) and the fabric communication protocol used by fabric 32 (in the present example Nvlink) may have different characteristics. In some embodiments, TEPs 48 implement various mechanisms that reconcile these differences. In the example embodiments described herein, TEPs 48 implement a tunneling protocol referred to as PCIe Tunneling Protocol (PCTP). In these embodiments, TEPs 48 typically support some or all of the following mechanisms (each described in detail further below):
Protocol bridging: In the egress direction, protocol bridging involves encapsulating PCIe Transaction Layer Packets (TLPs) to produce Nvlink packets. In the ingress direction, protocol bridging involves decapsulating the Nvlink packets to recover the original PCIe TLPs. Encapsulation and decapsulation may include modification of the original TLPs during the tunneling process. Encapsulation header construction typically involves translation between PCIe address/requestor ID and network address.
Credit control: Since tunnel 44 emulates, for example, a PCIe link, TEPs 48 also consume and release tunneled credits, to comply with PCIe credit control.
Transaction ordering: TEPs 48 allow transparent transmission and receipt of the various PCIe transaction types (Config, message, MMIO, DMA, MSI-X, etc.). At the same time, the TEPs maintain PCIe transaction ordering and blocking rules. The underlying fabric (e.g., Nvlink fabric 32) does not natively enforce these ordering rules.
Multipathing (e.g., spraying and reordering): To provide high performance and/or maintain the fabric's balance, especially for DMA traffic, TEPs 48 may distribute the traffic of a given tunnel 44 over multiple different paths via Nvlink fabric 32. The TEPs typically perform both balanced spraying of PCIe TLPs over the multiple paths (on ingress), and reordering the tunneled TLPs arriving over the multiple paths (on egress).
Fragmentation: The largest packet size supported by Nvlink fabric 32 (referred to as Maximum transmission unit-MTU) may be smaller than the PCIe MaxPayloadSize. In such cases, TEPs 48 are responsible for fragmentation of large PCIe payloads on ingress, and aggregation on egress.
Coalescing: For performance reasons, several TLPs may be aggregated into a single tunneling frame. TEPs 48 are responsible for coalescing at tunnel egress and separating at tunnel ingress.

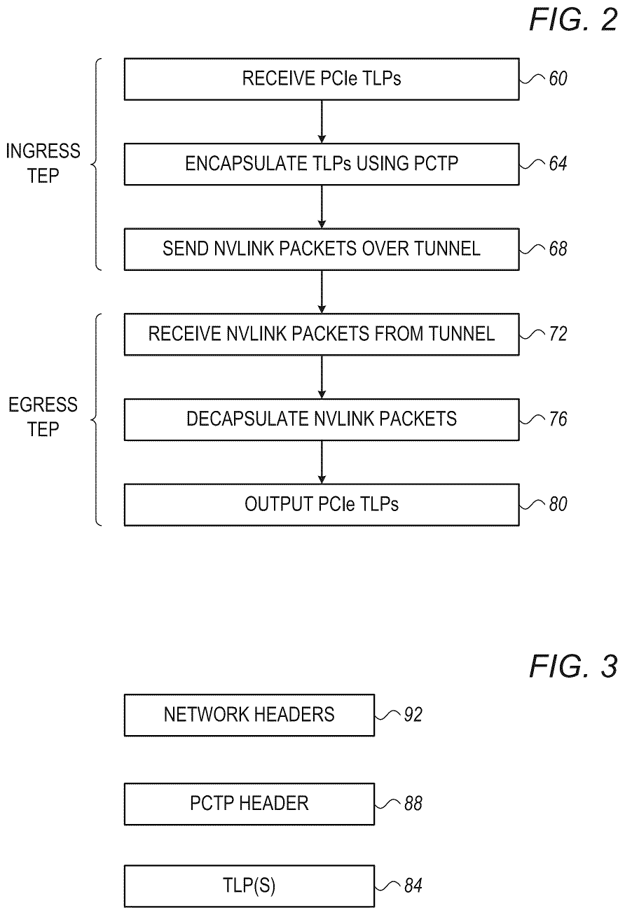

FIG. 2 is a flow chart that schematically illustrates a method for communicating between a host 24 and a disaggregated NIC 28, in accordance with an embodiment that is described herein.

The method begins with the TEP 48 associated with host 24 (referred to as an ingress TEP) receiving PCIe TLPs from the host, at a TLP input stage 60. At an encapsulation stage 64, the egress TEP encapsulates the TLPs in accordance with PCTP, so as to produce Nvlink packets. At a tunnel transmission stage 68, the egress TEP sends the Nvlink packets over tunnel 44 via Nvlink fabric 32.

At a tunnel reception stage 72, the TEP 48 associated with NIC 28 (referred to as an ingress TEP) receives the Nvlink packets from Nvlink fabric 32 over tunnel 44. At a decapsulation stage 76, the ingress TEP decapsulates the Nvlink packets in accordance with PCTP, so as to reproduce the original PCIe TLPs sent by the host. At a TLP output stage 80, the ingress TEP outputs the PCIe TLPs to NIC 28.

The flow of FIG. 2 is a simplified flow chosen purely for the sake of conceptual clarity. In alternative embodiments, any other suitable flow can be used. For example, a similar method can be used for sending PCIe TLPs from a disaggregated NIC 28 to a host 24.

### PCTP and Protocol Bridging

FIG. 3 is a diagram that schematically illustrates the protocol stack of PCTP, in accordance with an embodiment that is described herein. In the present example, a stream of Nvlink packets comprises PCIe TLPs 84, which are encapsulated in PCTP headers 88, which are in turn encapsulated in network headers 92. PCIe TLPs 84 are the original PCIe traffic provided to the egress TEP 48. The

egress TEP encapsulates TLPs 84 with PCTP headers 88 and then with network headers 92, so as to produce Nvlink packets. At the opposite end of tunnel 44, the ingress TEP 48 performs the reverse process, i.e., decapsulates network headers 92 and PCTP headers 88 so as to reproduce the original PCIe TLPs 84.

PCTP headers 88 comprise various metadata used by TEPs 48 for performing the various PCTP mechanisms (e.g., credit control, transaction ordering, spraying, fragmentation and/or coalescing). Network headers 92 are associated with an upper-layer protocol. In various embodiments, PCTP can be implemented with a single type of upper-layer protocol or with multiple types of upper-layer protocols. This feature is useful, for example, for multiplexing multiple different services over the same fabric 32. Moreover, the same fabric 32 may be used for multiplexing both native Nvlink traffic and PCTP traffic.

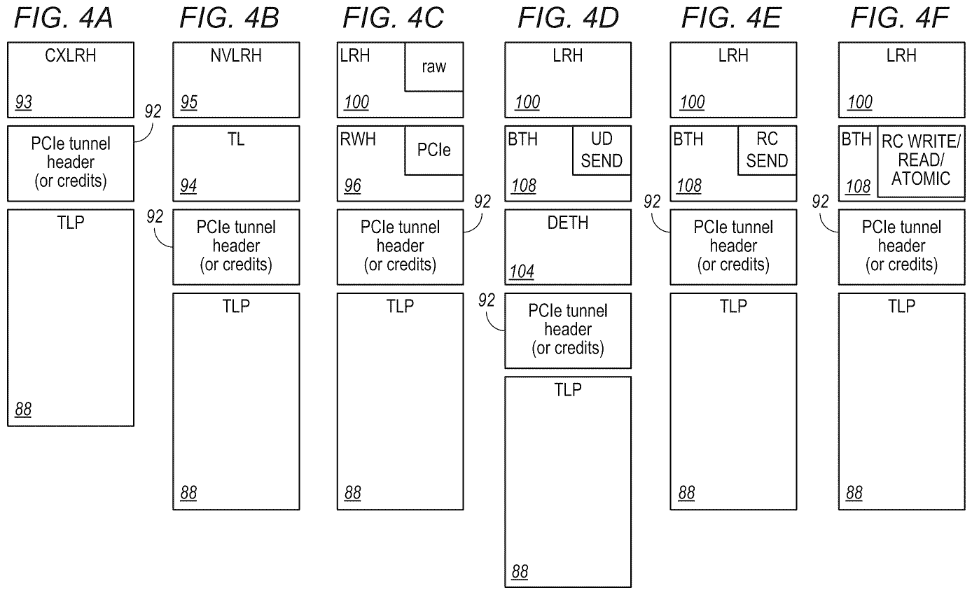

In some embodiments, encapsulation can be performed at various layers. Generally, a larger number of layers would allow a higher degree of sharing of underlaying infrastructure, at the cost of more bandwidth overhead, and vice versa. For example, disambiguation at the physical layer would typically require that switches within fabric 32 implement additional queuing mechanisms, since the link layer is not shared. Several examples of PCTP packet formats are given in FIGS. 4A-4F below.

FIGS. 4A-4F are diagrams that schematically illustrate PCTP packet formats, in accordance with embodiments that are described herein. In all these examples, the innermost part of the PCTP packet comprises a PCIe TLP 88, which is encapsulated in a PCIe tunnel header 92. In some implementations, tunnel header 92 is an encapsulation header that encapsulates TLP 88. In some implementations, tunnel header 92 is itself part of the PCTP protocol, e.g., may contain credit release information.

In FIG. 4A, PCIe tunnel header 92 is encapsulated with a Local Routing Header (LRH) referred to as CXLRH 93. In this implementation, the PCTP packet is transported over the Nvlink infrastructure but is not a compliant Nvlink packet. Since the link layer is not shared, disambiguation should be performed the physical layer using a symbol.

In FIG. 4B, PCIe tunnel header 92 is encapsulated in an Nvlink Transaction Layer (TL) 94 that specifies “PCIe tunnel”, which is in turn encapsulated in n Nvlink LRH (NVLRH) 95. The PCTP packet of FIG. 4B is regarded by the Nvlink fabric as a native Nvlink packet.

In FIG. 4C, PCIe tunnel header 92 is encapsulated with an InfiniBand (IB) Raw Header (RWH) 96, and then with an IB Local Route Header (LRH) 100.

In FIG. 4D, PCIe tunnel header 92 is encapsulated with a Datagram Extended Transport Header (DETH) 104, a Base Transport Header (BTH) 108, and then LRH 100.

In FIG. 4E, PCIe tunnel header 92 is encapsulated with BTH 108 and LRH 100.

In FIG. 4F, too, PCIe tunnel header 92 is encapsulated with BTH 108 and LRH 100. In this case, however, the tunneled TLP 88 can be sent using RDMA directly to a remote queue, and free queue slots can be signaled back using WRITE or ATOMIC commands.

The encapsulation schemes seen in FIGS. 4A-4F are example schemes that are chosen purely for the sake of conceptual clarity. In alternative embodiments, TEPs 48 may encapsulate the PCIe traffic in any other suitable way.

For example, in the above examples the TEPs encapsulate individual TLPs. This sort of encapsulation involves adding headers for communicating the release of PCIe credits. This, however, is not mandatory. in some embodiments the PCIe traffic comprises a sequence of PCIe Flow-Control units (“FLITs”). The use of FLITs is specified, for example, in the PCI Express Base Specification, Revision 6.0, December, 2021, chapter 4.2.3.

TEPs 48 may encapsulate individual PCIe FLITs by adding network headers, where in some cases less functionality is maintained by the PCTP layer (such as credit control). Note that this sort of encapsulation can be used even if the source of the PCIe traffic (host or NIC) does not support FLITs. In these cases, the FLITs can be constructed by TEPs 48. When using encapsulation of individual FLITs, the destination of the PCIe traffic (host or NIC) can process the received FLITs as if they originate from a local PCIe bus, without having to add any additional parsing or other processing layers.

### ID/Address Translation and Lookup

Typically, the destination of a PCIe TLP is specified in terms of a suitable address or identifier (ID). Some PCIe transactions are referred to as “address routed” —these transactions specify a destination address in an address space of the peripheral-bus protocol, for example a PCIe Base Address Register (BAR) address. Other PCIe transactions are referred to as “ID routed”. ID routed transactions specify an ID associated with the destination, e.g., a Destination ID (DID) or a virtual NIC (vNIC) ID.

In order to route encapsulated PCIe traffic correctly over Nvlink fabric 32, network headers 92 of the Nvlink packets should specify the correct network addresses or network IDs of the intended destinations of the traffic. The network address or network ID specifying the destination may comprise, for example, a Medium Access Control (MAC) address, an Internet Protocol (IP) address, InfiniBand Local Identifier (LID), Destination Global ID (DGID), or any other suitable type of address or network ID.

In some embodiments, TEPs 48 comprise (or otherwise have access to) lookup tables that specify a respective network address or network ID pe PCIe address, address range or identifier. When encapsulating a certain PCIe TLP, the egress TEP 48 queries a lookup table with the PCIe address or ID, to obtain the appropriate network address or ID. The egress TEP then inserts the network address or ID in the network header of the Nvlink packet. The lookup tables are typically created by disaggregation controller 40. Controller 40 may also modify the lookup tables over time, e.g., on system reconfiguration.

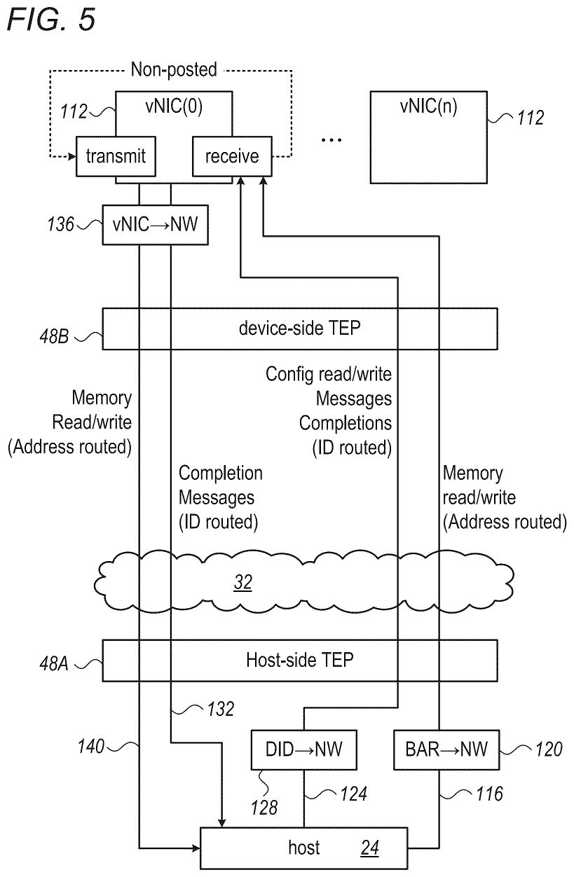

FIG. 5 is a block diagram that schematically illustrates address lookup operations in PCTP, in accordance with an embodiment that is described herein. In the present example, a host 24 uses the networking resources of multiple vNICs 112 using the disclosed tunneling techniques. A vNIC is a logical construct that provides the networking functionality of a NIC to a host 24, using resources of a physical NIC 28. A physical NIC 28 may run a single vNIC 112 or multiple vNICs 112. A vNIC may be represented over PCIe by a NIC physical function (PF), a NIC virtual function (VF), or a sub-function of a PF or VF. The PF, VF or sub-function may be identified, for example by an address, a DID and/or a Process Address Space ID (PASID).

A host-side TEP 48A serves host 24. A device-side TEP 48B serves vNICs 112. The figure illustrates several types of PCIe transactions, and the respective types of address/ID lookups used for encapsulating them:
Address routed PCIe transactions 116 from host 24 to vNICs 112. Such transactions may comprise, for example, memory read and write transactions. A given PCIe transaction 116 specifies its destination in terms of a PCIe BAR address. Host-side TEP 48A therefore holds a lookup table 120 that specifies respective network addresses for the relevant BAR addresses.
ID routed PCIe transactions 124 from host 24 to vNICs 112. These transactions may comprise, for example, configuration read and write transactions, and/or completion transactions. A given PCIe transaction 124 specifies its destination in terms of a Destination ID (DID). To encapsulate these transactions, host-side TEP 48A holds a lookup table 128 that specifies respective network addresses for the relevant RIDs.
ID routed PCIe transactions 132 from vNICs 112 to host 24. These transactions may comprise, for example, completion messages. A given PCIe transaction 132 specifies its destination in terms of a host ID. To encapsulate these transactions, device-side TEP 48B holds a lookup table 136 that specifies respective network addresses for the relevant host IDs.
Address routed PCIe transactions 140 from vNICs 112 to host 24. These transactions may comprise, for example, memory read and write messages. A given PCIe transaction 140 specifies its destination in terms of a vNIC ID, similarly to transactions 132. Lookup table 136 can be used to encapsulate these transactions, as well.

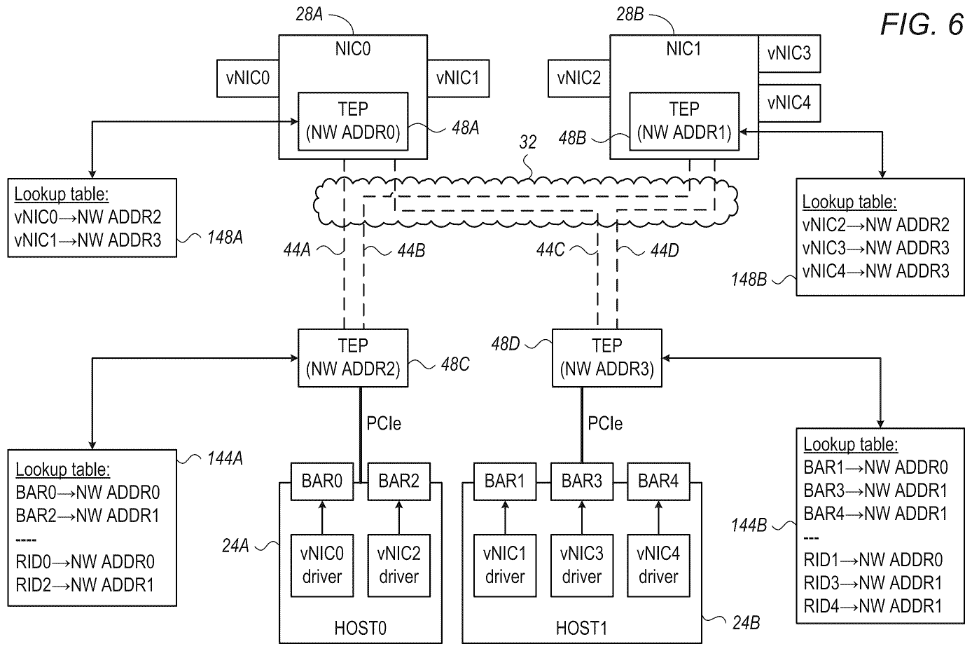

FIG. 6 is block diagram that schematically illustrates a system level example of address lookup operations in PCTP, in accordance with an embodiment that is described herein. In the present example, the system comprises two hosts 24 denoted “HOST0” and “HOST1” and two disaggregated NICs 28 denoted “NIC0” and “NIC1”.

Four tunnels, denoted 44A-44D, are established via Nvlink fabric 32. HOST0 communicates with NIC0 over tunnel 44A, and with NIC1 over tunnel 44B. HOST1 communicates with NIC0 over tunnel 44C, and with NIC1 over tunnel 44D.

A TEP 48A serves NIC0 and is assigned a network address denoted “NW_ADDR0”. A TEP 48B serves NIC1 and is assigned a network address denoted “NW_ADDR1”. A TEP 48C serves HOST0 and is assigned a network address denoted “NW_ADDR2”. A TEP 48C serves HOST1 and is assigned a network address denoted “NW_ADDR3”.

HOST0 accesses a network (not seen in the figure) using two vNICs—(i) vNIC0 running in NIC0 and (ii) vNIC2 running in NIC1. To access vNIC0, HOST0 runs a driver

denoted “vNIC0 driver” that is assigned a PCIe BAR address denoted BAR0. To access vNIC2, HOST0 runs a driver denoted “vNIC2 driver” that is assigned a PCIe BAR address denoted BAR2.

HOST1 accesses the network using three vNICs—(i) vNIC1 running in NIC0 (ii) vNIC3 running in NIC1, and (iii) vNIC4 running in NIC1. To access vNIC1, HOST1 runs a driver denoted “vNIC1 driver” that is assigned a PCIe BAR address denoted BAR1. To access vNIC3, HOST1 runs a driver denoted “vNIC3 driver” that is assigned a PCIe BAR address denoted BAR3. To access vNIC4, HOST1 runs a driver denoted “vNIC4 driver” that is assigned a PCIe BAR address denoted BAR4.

TEP 48C of HOST0 accesses a lookup table 144A for encapsulating PCIe transactions on egress to tunnels 44A and 44B. Lookup table 144A comprises the following entries:
BAR0→NW_ADDR0: For encapsulating address-routed PCIe transactions from vNIC0 driver to vNIC0 on NIC0. This mapping ensures that the Nvlink packets destined to vNIC0 will be tunneled via tunnel 44A.
BAR2→NW_ADDR1: For encapsulating address-routed PCIe transactions from vNIC2 driver to vNIC2 on NIC1. This mapping ensures that the Nvlink packets destined to vNIC2 will be tunneled via tunnel 44B.
RID0→NW_ADDR0: For encapsulating ID-routed PCIe transactions from vNIC0 driver to vNIC0 on NIC0.
RID2→NW_ADDR1: For encapsulating ID-routed PCIe transactions from vNIC2 driver to vNIC2 on NIC1.

In a similar manner, TEP 48D of HOST1 accesses a lookup table 144B for encapsulating PCIe transactions on egress to tunnels 44C and 44D. Lookup table 144B comprises the following entries:
BAR1→NW_ADDR0: For encapsulating address-routed PCIe transactions from vNIC1 driver to vNIC1 on NIC0. This mapping ensures that the Nvlink packets destined to vNIC0 will be tunneled via tunnel 44C.
BAR3→NW_ADDR1: For encapsulating address-routed PCIe transactions from vNIC3 driver to vNIC3 on NIC1. This mapping ensures that the Nvlink packets destined to vNIC 3 will be tunneled via tunnel 44D.
BAR4→NW_ADDR1: For encapsulating address-routed

PCIe transactions from vNIC4 driver to vNIC4 on NIC1. This mapping ensures that the Nvlink packets destined to vNIC 4 will be tunneled via tunnel 44D.
RID1→NW_ADDR0: For encapsulating ID-routed PCIe transactions from vNIC1 driver to vNIC1 on NIC0.
RID3→NW_ADDR1: For encapsulating ID-routed PCIe transactions from vNIC3 driver to vNIC3 on NIC1.
RID4→NW_ADDR1: For encapsulating ID-routed PCIe transactions from vNIC4 driver to vNIC4 on NIC1.

TEP 48A of NIC0 accesses a lookup table 148A for encapsulating PCIe transactions on egress to tunnels 44A and 44C. Lookup table 148A comprises the following entries:
vNIC0→NW_ADDR2: For encapsulating PCIe transactions from vNIC0 on NIC0 to vNIC0 driver on HOST0. This mapping ensures that the Nvlink packets destined to HOST0 will be tunneled via tunnel 44A.
vNIC1→NW_ADDR3: For encapsulating PCIe transactions from vNIC1 on NIC0 to vNIC1 driver on HOST1. This mapping ensures that the Nvlink packets destined to HOST1 will be tunneled via tunnel 44C.

Similarly, TEP 48B of NIC1 accesses a lookup table 148B for encapsulating PCIe transactions on ingress to tunnels 44B and 44D. Lookup table 148B comprises the following entries:
vNIC2→NW_ADDR2: For encapsulating PCIe transactions from vNIC2 on NIC1 to vNIC2 driver on HOST0.
vNIC3→NW_ADDR3: For encapsulating PCIe transactions from vNIC3 on NIC1 to vNIC3 driver on

HOST1.
vNIC4→NW_ADDR3: For encapsulating PCIe transactions from vNIC4 on NIC1 to vNIC4 driver on HOST1.

The transaction types, and the corresponding types of

lookup and translation, seen in FIGS. 5 and 6, are non-limiting examples that were chosen purely for the sake of conceptual clarity. In alternative embodiments, TEPs 48 may perform any other suitable lookup and translation operations in order to specify the destinations of tunneled packets.

When a given host 24 is served by multiple vNICs on the same physical NIC 28, various tunnel configurations can be used. In one embodiment, a unique tunnel 44 is established between the host and each of the multiple vNICs. In an alternative embodiment, a shared tunnel 44 is used for communicating between the host and the multiple vNICs. The latter implementation is efficient, since it involves a single table entry, a single reorder buffer and/or a single set of TLP queues, as appropriate. When using a shared tunnel, A vNIC ID is typically associated with a “tunnel ID”, and the “tunnel” object holds all relevant control fields (e.g., credits, sequence numbers and network destination address).

### Credit Control

For a given tunnel 44, the end-to-end connection between the pair of TEPs 48 is expected (by host 24 and NIC 28) to behave as a fully compliant PCIe link. As such, TEPs 48 are typically required to support PCIe credit control between the host and the NIC. In some embodiments, TEPs 48 implement credit control at the level of individual FLITs. In other embodiments, TEPs 48 implement credit control at the level of TLPs (typically as part of the PCTP header).

Note that this end-to-end credit control between TEPs 48 is separate from, and not to be confused with, any underlying network-level flow control that may exist in fabric 32.

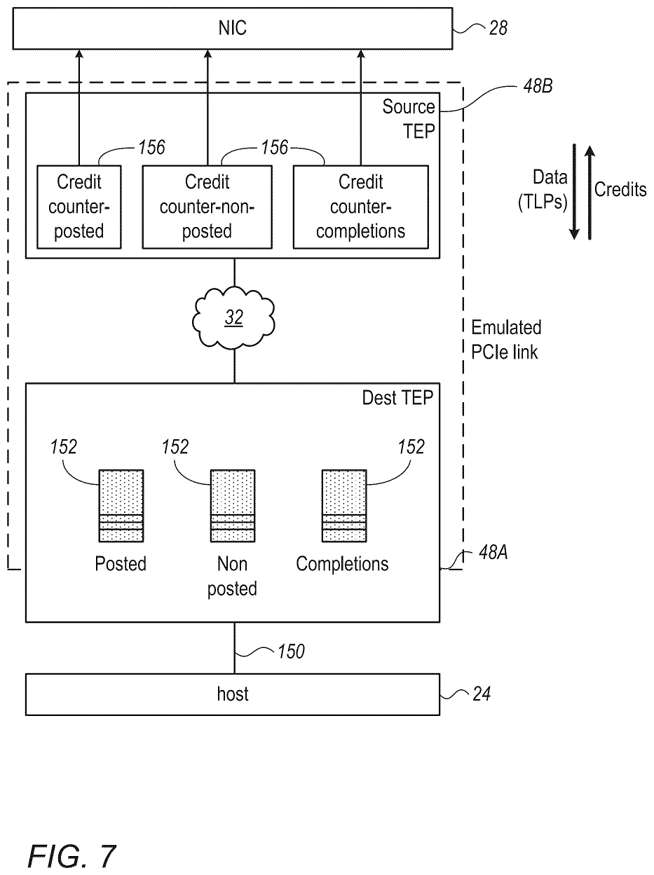

FIG. 7 is a block diagram that schematically illustrates end-to-end credit control over a PCIe tunnel, in accordance with an embodiment that is described herein. In this non-limiting example, NIC 28 serves as the source of the PCIe TLPs and host 24 serves as the destination. Device-side TEP 48B is therefore referred to as a “Source TEP”, and host-side TEP 48A is referred to as a “Destination TEP”. TLPs in this example flows from NIC 28 to host 24. Credits flow in the opposite direction—From destination TEP 48B to source TEP 48A.

Host 24 is connected to destination TEP 48A by a physical PCIe link 150. Host 24 and TEP 48A implement a conventional PCIe credit control mechanism over link 150, entirely decoupled from the end-to-end credit control between TEPs 48A and 48B.

To comply with PCIe rules, destination TEP 48A comprises separate TLP queues 152 for posted transactions, for non-posted transactions, and for completions. Transactions of each type (posted, non-posted and completions) are queued separately from the other types. The end-to-end credit mechanism between TEPs 48A and 48B should ensure that none of the TLP queues 152 overfills.

To meet this requirement, in some embodiments, TEPs 48A and 48B implement a separate credit-control loop for each transaction type. In the example of FIG. 7, source TEP 48A comprises three separate credit counters 156—One counter for posted transactions, another counter for non-posted transactions, and a third counter for completions. Each credit counter 156 holds the current number of credits remaining for the corresponding transaction type.

For each transaction type, destination TEP 48A sends source TEP 48B credit messages that allocate credits in accordance with the available space in the corresponding TLP queue 152. Source TEP 48B increments credit counters 156 in accordance with the credit messages received from destination TEP 48A.

Before sending a TLP to TEP 48A, TEP 48B checks whether credit counter 156 of the corresponding transaction type indicates there are sufficient credits for queuing the TLP at TEP 48B. The TLP can be sent only if sufficient credits are available. Upon sending a TLP, TEP 48B (“consumes credits”) by decrementing the credit counter 156 of the corresponding transaction type.

Typically, the total number of credits per transaction type is set up by controller 40.

As noted above, this process is performed independently per transaction type (posted, non-posted and completions). Since posted transactions are guaranteed to be drained by physical PCIe link 150, destination TEP 48A is guaranteed to release posted credits. Since credits for posted transactions are independent of credits for non-posted transactions, forward progress of transactions of each type is not affected by transactions of other types.

### Transaction Ordering

The PCIe specification defines rules relating to ordering among PCIe transactions. In the present context, the term “transaction ordering” refers to the order in which transactions are delivered to the destination of a PCIe link, relative to the order of the transactions produced by the source of the PCIe link. One example rule requires that non-posted transactions must not bypass posted transactions.

Nvlink fabric 32, on the other hand, may not guarantee that the PCIe ordering rules are always met. For example, fabric 32 may transfer a flow of transactions over multiple different paths having different latencies, thereby modifying the original order of the transactions. As another example, fabric 32 may use multiple Virtual Lanes (VLs), e.g., for performance tuning. In other configurations fabric 32 may use a single VL for all traffic, guaranteeing in-order delivery within each VL. In these configurations, too, transactions of different types (posted, non-posted, completions) are queued in different TLP queues 152, and therefore measures should be taken to preserve ordering according to PCIe rules.

Thus, in some embodiments, TEPs 48 are responsible for maintaining transaction ordering that meets the PCIe rules. In various embodiments, TEPs 48 maintain transaction ordering in different ways.

### Destination-Side Sequencing

Consider, for example, a configuration in which Nvlink fabric 32 uses a single VL for all traffic, and therefore guarantees in-order delivery of packets. In this configuration, it is sufficient for the ingress TEP (destination TEP) to ensure that the TLPs are read from the different TLP queues 152 in an order that complies with PCIe rules. This sort of configuration is referred to herein as “destination-side sequencing”.

Before distributing the received TLPs to queues 152, TEP 48A adds a timestamp or other ordering identifier to each TLP. When reading the heads of queues 152 (“dequeuing the TLPs”), TEP 48A sends the TLPs to host 24 in an order that preserves the PCIe ordering rules, based on the ordering identifiers.

In this configuration, TEPs 48A and 48B typically implement credit control per transaction type as in FIG. 7. Destination-side TEP 48A typically holds a bitmap or other data structure that indicates which sequence numbers (i.e., TLPs having which sequence numbers) have already been popped from TLP queues 152. The destination-side TEP pops subsequent TLPs from the TLP queues using this data structure, to ensure that ordering is preserved. Once a TLP having a certain sequence number has been popped from the head of a TLP queue 152, destination TEP 48A may release this sequence number (i.e., permit source-side TEP 48B to reuse this sequence number).

### Source-Side Sequencing

The destination-side sequencing scheme described above is suitable for configurations in which Nvlink fabric 32 guarantees in-order delivery of packets. In some configurations, however, fabric 32 cannot provide this guarantee (e.g., because it uses multiple VLs, or for any other reason).

Thus, in some embodiments, TEPs 48A and 48B maintain PCIe-compliant transaction ordering using “source-side sequencing”. In source-side sequencing, the ordering identifiers (timestamps or otherwise) are added to the encapsulated packets by source TEP 48B before the packets are sent via tunnel 44. The ordering identifiers may be added, for example, in the PCTP headers of the encapsulated packets.

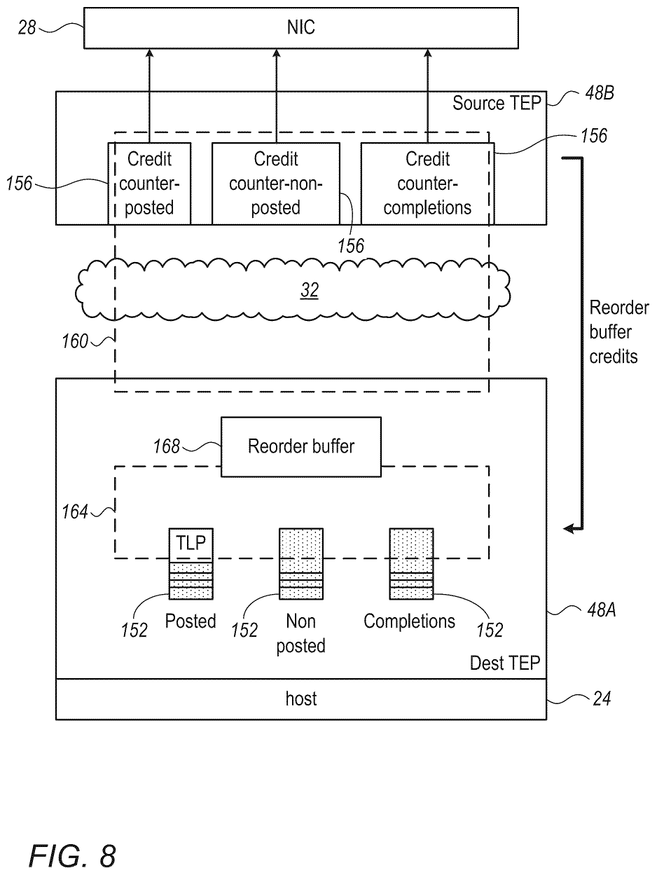

FIG. 8 is a block diagram that schematically illustrates transaction ordering over a PCIe tunnel using source-side sequencing, in accordance with an embodiment that is described herein. In the example of FIG. 8, Nvlink fabric 32 does not guarantee in-order delivery of packets from source TEP 48B to destination TEP 48A. Within destination TEP 48A, the TLPs are distributed to three TLP queues 152 depending on the transaction type (posted, non-posted, completions).

In an embodiment, destination TEP 48A comprises a reorder buffer 168. Buffer 168 buffers the TLPs arriving over tunnel 44 from source TEP 48B, before the TLPs are distributed to TLP queues 152. When reading TLPs from buffer 168 and sending them to queues 152, TEP 48A adds a timestamp or other ordering identifier to each TLP. When reading the heads of queues 152 (“dequeuing the TLPs”), TEP 48A sends the TLPs to host 24 in an order that preserves the PCIe ordering rules, based on the ordering identifiers.

In this configuration, TEPs 48A and 48B do not need to implement credit control per transaction type as in FIG. 7, because the TLPs of all types are buffered in reorder buffer 168 on arrival. Instead, the TEPs implement a single credit control loop that ensures that reorder buffer 168 does not overfill.

Destination-side TEP 48A typically holds a bitmap or other data structure that indicates which sequence numbers (i.e., TLPs having which sequence numbers) have already been popped from TLP queues 152. The destination-side TEP pops subsequent TLPs from the TLP queues using this data structure, to ensure that ordering is preserved. Once a TLP having a certain sequence number has been popped from the head of a TLP queue 152, destination TEP 48A may release this sequence number (i.e., permit source-side TEP 48B to reuse this sequence number).

In the scheme of FIG. 8, tunnel 44 can be viewed as a cascade of two sections denoted 160 and 164. In section 160, in-order delivery of packets (encapsulated Nvlink packets) is not guaranteed, and reordering is later maintained using reorder buffer 168. In section 164, transaction ordering according to PCIe rules is maintained by TEP 48A using the ordering identifiers. Since the ordering identifiers are assigned on ingress to the tunnel, out-of-order packet delivery in fabric 32 does not disrupt the transaction ordering.

When using source-side sequencing, source TEP 48B allocates ordering identifiers to packets from a finite range, e.g., sequentially with a certain wraparound period. It is important to ensure that TEP 48B allocates unique ordering identifiers, i.e., that each ordering identifier appears no more than once in the packets present in the system.

One way of preventing duplicate identifiers is to define an extremely large identifier size (e.g., 64 bits). This solution, however, incurs considerable bandwidth. In other embodiments, TEPs 48A and 48B use smaller-size ordering identifiers. To prevent duplication, TEPs 48A and 48B implement a mechanism that allows source TEP 48B to allocate a certain identifier only after the previous TLP having this identifier has been pushed to queues 152 in destination TEP 48A.

The source TEP can be notified in various ways that a certain ordering identifier has been “released” (i.e., pushed to queues 152) and can be reallocated. For example, if fabric 32 uses reliable transport, e.g., InfiniBand Reliable Connected (RC) transport, source TEP 48B can track whether a packet has been delivered to destination TEP 48A. In other embodiments, destination TEP 48A may send explicit notifications to source TEP 48B, indicating which ordering identifiers have been released. Such notifications can be “piggybacked”, for example, on credit messages sent from the destination TEP to the source TEP.

Further alternatively, the source and destination TEPs may use any other suitable mechanism for complying with PCIe transaction ordering rules.

### Multipathing, e.g., Spraying and Reordering

In some embodiments, a pair of TEPs 48 of a given tunnel 44 distributes the Nvlink packets between them over a plurality of different paths via fabric 32. A given path is typically defined by, or derived from, a respective combination of header field values of the Nvlink packet. The packets may also be divided into a number of links (streams), which is typically smaller than or equal to the number of paths.

The use of multiple paths is useful, for example, when the total bandwidth of the traffic entering tunnel 44 exceeds the bandwidth of a single path of fabric 32. Moreover, even if the total bandwidth of the traffic entering tunnel 44 is below the bandwidth of a single path, multipathing helps to balance the traffic, e.g., accounting for other traffic traversing fabric 32.

Sending traffic over multiple paths, by the source-side TEP, is also referred to as “spraying”. The source-side TEP may divide the total bandwidth among the multiple paths in various ways, e.g., uniformly, statistically, in accordance with a user-defined configuration, based on dynamic network information (e.g., occupancy of the different paths by other traffic), etc.

Since the different paths may differ in latency, the destination-side TEP typically needs to reorder the Nvlink packets arriving over the different paths before decapsulating them. Any of the reordering techniques described above for complying with PCIe ordering rules (e.g., the various destination-side sequencing and source-side sequencing schemes) can be used for reordering sprayed traffic, as well. In some embodiments, if the difference in latency between the paths is significant, the destination-side TEP may need considerable buffer space (e.g., a large reorder buffer) for reordering.

In an embodiment, a simpler reordering process can be used if (i) fabric 32 guarantees in-order delivery of packets over any individual path and (ii) the spraying pattern used by the source-side TEP is known and deterministic. If these conditions are met, the destination-side TEP may reorder the arriving packets by reversing the spraying pattern of the source-side TEP. For example, if the source-side TEP sprays the packets in a Round-Robin scheme, the destination-side TEP may reorder the packets using the same Round-Robin order.

### Reorder Buffer Implementations

In various embodiments, reorder buffer 168 in destination-side TEP 48A can be implemented in various ways. In some embodiments, reorder buffer 168 is implemented separately from TLP queues 152, as seen in FIG. 8. In other embodiments, TLP queues 152 themselves serve as a reorder buffer (in addition to transaction-type-specific queuing of TLPs).

In an example embodiment, when queuing TLPs in queues 152, destination-side TEP 48A assigns the queued TLPs a global sequence number (i.e., a sequence number that is not transaction-type specific). When serving the different TLP queues 152, destination-side TEP 48A pops a TLP from a certain queue 152 only if all previous sequence numbers have been popped. In this manner, each TLP is implicitly dependent on the delivery of all previous TLPs. This mechanism does not break PCIe transaction ordering rules, since fabric 32 will eventually deliver these packets.

In another embodiment, the dependency between TLPs can be defined implicitly. For example:
A. Each TLP declares the sequence number of the posted TLP it is ordered after, and
B. Each non-posted TLP and each completion TLP declares both (i) the sequence number of the posted TLP it is ordered after, and (ii) the sequence number of the completion TLP it is ordered after.

An alternative to declaration (B), incurring less overhead, is:
C. Each non-posted TLP and each completion TLP declares the maximum of (i) the sequence number of the posted TLP it is ordered after, and (ii) the sequence number of the completion TLP it is ordered after.

The implicit dependency schemes relax the constraints on forwarding the TLPs by the destination-side TEP, and therefore increases efficiency.

In an embodiment, when using explicit declaration of dependencies in the TLPs, the destination-side TEP may assign the queued TLPs a separate sequence number per transaction type (i.e., a separate sequence number per TLP queue 152). When serving TLP queues 152, the destination TEP still maintains the dependencies between different transaction types, e.g., non-posted TLP with sequence number X depends on posted TLP with sequence number Y.

In implementations in which destination-side TEP 48A delays popping a TLP from TLP queue 152 until all prior sequence numbers have arrived for the type of TLP, it is possible to only release credits, without a need to additionally release sequence numbers. Note that in accordance with the PCIe specification, PCIe credits contain both header credits and data credits. Typically, sequence numbers are released according to header credit release.

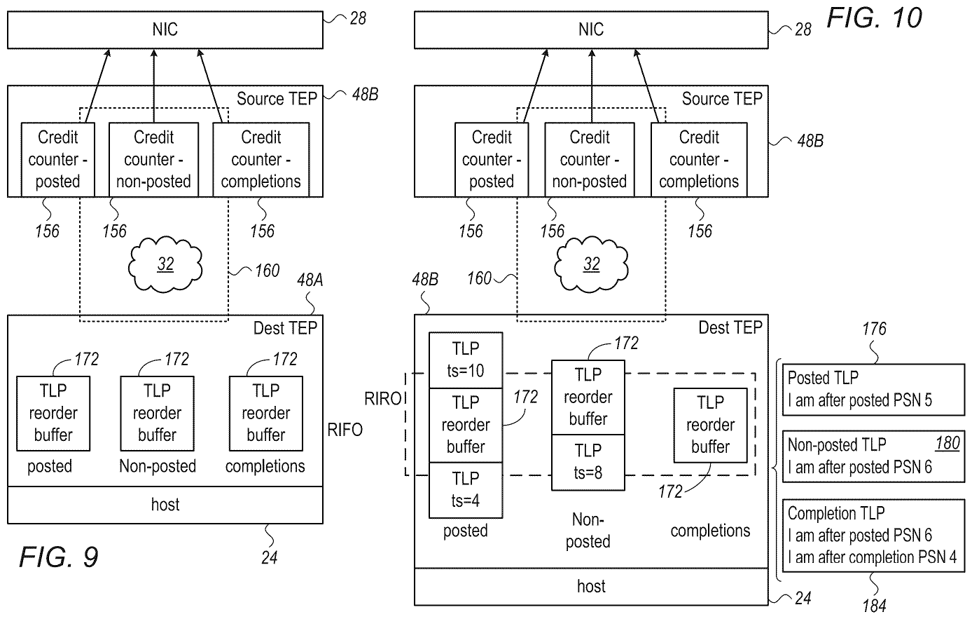

FIG. 9 is a block diagram that schematically illustrates a configuration in which a TLP reorder buffer is implemented jointly with TLP queues, in accordance with an embodiment that is described herein. In FIG. 9, instead of separate reorder buffer 168 and TLP queues 152 as in FIG. 8, destination-side TEP 48A comprises a respective TLP reorder buffer 172 for each transaction type (posted, non-posted, completion). TEP 48A manages buffers 172 in a Random-In First-Out (RIFO) manner.

Buffers 172 are used both for (i) in-order delivery according to the sequence numbers assigned to the TLPS, and

(ii) ensuring that PCIe ordering rules are met, e.g., with regards to ordering among transaction types.

In this implementation, too, destination-side TEP 48A typically holds a bitmap or other data structure that indicates which sequence numbers (i.e., TLPs having which sequence numbers) have already been popped from reorder buffers 172. Once a TLP having a certain sequence number has been read from a buffer 172, destination TEP 48A may release this sequence number (i.e., permit source-side TEP 48B to reuse this sequence number).

FIG. 10 is a block diagram that schematically illustrates another alternative reorder buffer implementation, in accordance with an embodiment that is described herein. This implementation is similar to that of FIG. 9 above, with the addition that the TLPs buffered in reorder buffers 172 contain explicit declarations of dependency. These declarations are added by source TEP 48B, to improve the performance of destination-side TEP 48A in popping TLPs from buffers 172.

The right-hand side of FIG. 10 shows three examples of explicit dependency declarations. An example posted TLP 176 contains a declaration that it depends on the posted TLP having sequence number PSN=5. An example non-posted TLP 180 contains a declaration that it depends on the posted TLP having sequence number PSN=6. An example completion TLP 184 contains a declaration that it depends on the posted TLP having sequence number PSN=6, and also depends on the completion TLP having sequence number PSN=4.

Typically, destination-side TEP 48A regards the explicit dependency declarations as relaxations to the strict order of sequence numbers. Consider, for example, a buffered TLP having PSN=X, which contains an explicit declaration of dependence on PSN=Y (Y>X). This declaration is interpreted as “TLP PSN=X depends on TLP PSN=Y, but not on the other TLPs having PSNs that precede X.” Thus, TEP 48A is permitted to pop the TLP having PSN=X as soon as TLP PSN=Y has arrived, without a need to wait for all other TLPs whose sequence numbers precede X. As can be appreciated, this mechanism reduces latency and allows more flexibility in popping TLPs from reorder buffers 172.

### Fragmentation

The largest packet size supported by Nvlink fabric 32 (referred to as Maximum transmission unit-MTU) may be smaller than the maximal PCIe payload size. In an example system configuration, the PCIe payload size may reach 4 KB, whereas the MTU of fabric 32 is only 256 B. Thus, in some embodiments, as part of the PCTP, source-side TEP 48B divides long TLPs into fragments on egress to tunnel 44, and sends each fragment in a separate encapsulated Nvlink packet (PCTP packet). On egress from tunnel 44, destination-side TEP 48A reassembles the long TLPs from the received fragments.

To support the fragmentation mechanism, destination-side TEP 48A should be provided with sufficient information for identifying the set of fragments belonging to a fragmented TLP, and their order in the TLP. If fabric 32 guarantees in-order delivery, destination-side TEP 48A can obtain this information from a “TLP length” indicator that is contained in the TLP header sent in the first fragment. If the TLP length is larger than the MTU, TEP 48A can deduce that the TLP has been fragmented, and that subsequent Nvlink packets will convey subsequent fragments of the TLP. The TLP length parameter also enables TEP 48A to determine the number of fragments into which the TLP has been fragmented. A similar technique can be used when using the Round-Robin spraying technique, described above.

If, on the other hand, fabric 32 does not guarantee in-order delivery, TEPs 48A and 48B should use other means for supporting fragmentation and reassembly. Example solutions are described below. These solutions are related to the type of reordering scheme used by the TEPs (e.g., depending on whether the TEPs use the reordering scheme of FIG. 8, 9 or 10).

### Fragmentation With Global Reorder Buffer

In an embodiment, when using the reordering scheme of FIG. 8, no additional measures are needed for supporting fragmentation. In FIG. 8, each Nvlink packet (and thus each fragment) is assigned a separate sequence number. Reorder buffer 168 is now used for buffering individual fragments, as opposed to entire TLPs.

### Fragmentation With Reorder Buffer Per Transaction Type

In another embodiment, when using the reordering scheme of FIG. 9 (using a separate reorder buffer per PCIe transaction type), source-side TEP 48B specifies the following information in each Nvlink packet that conveys a respective fragment:
The type of PCIe transaction (posted, non-posted or completion) of the TLP to which the fragment belongs.
Whether the fragment is the first fragment of the TLP (and therefore contains the TLP header).

Source-side TEP 48B typically specifies this information in the PCTP header of the fragment. Destination-side TEP 48A uses this information to reassemble the TLP from the multiple received fragments. In an example reassembly process, the destination-side TEP parses the TLP header of the first fragment of a TLP, extracts the “TLP length” parameter, and calculates the number of fragments from the TLP length. The destination-side TEP then waits until the expected number of fragments arrive (regardless of the order of arrival), and reassembles the TLP.

In this embodiment, reorder buffers 172 (of FIG. 9) are used for buffering individual fragments, not entire TLPs. In addition, the condition for popping a given fragment from buffers 172 now requires that (i) PCIe ordering rules are met, (ii) all previous sequence numbers have arrived at the destination-side TEP, and (iii) all other fragments of the given fragment's TLP have also arrived at the destination-side TEP.

### Fragmentation With Reorder Buffer Per Transaction Type, and Explicit Declarations of Dependency in TLPs

In yet another embodiment, when using the reordering scheme of FIG. 10 (using a separate reorder buffer per PCIe transaction type, and using TLPs that specify explicit dependencies), fragmentation and reassembly may be implemented as follows:
As in the previous case, source-side TEP 48B specifies, per fragment (i) the type of PCIe transaction of the TLP to which the fragment belongs, and (ii) whether the fragment is the first fragment of the TLP.
Buffers 172 again buffer individual fragments, not entire TLPs. The buffered fragments specify explicit dependencies on previous TLPs. The PSNs in the dependency declarations specified in the buffered fragments are the PSNs of the last fragments of the dependent TLPs.
The condition for popping a given fragment from buffers 172 now requires that (i) PCIe ordering rules are met, (ii) all previous sequence numbers specified in the explicit dependency declaration in the given fragment have arrived at the destination-side TEP, and (iii) all other fragments of the given fragment's TLP have also arrived at the destination-side TEP.

### Coalescing

In some embodiments, source-side TEP 48B coalesces two or more TLPs and/or TLP fragments into a single encapsulated Nvlink packet (PCTP packet). Coalescing improves the bandwidth efficiency of communication over fabric 32, and also relaxes the requirements on message rate over fabric 32. The description below refers mainly to coalescing of entire TLPs, by way of example. Unless noted otherwise, however, the techniques described below can be used for coalescing of TLPs, TLP fragments, or a mix of TLPs and TLP fragments.

Coalescing may be applicable, for example, when the source-side TEP receives small TLPs (smaller than the MTU of Nvlink fabric 32) for transporting via tunnel 44, or when a last fragment of a certain TLP does not fill the current MTU.

When using coalescing, a coalesced PCTP packet should provide destination-side TEP 48A with sufficient information for fragmenting the packet into the original

TLPs. The implementation of coalescing is related to the type of reordering scheme used by the TEPs (e.g., depending on whether the TEPs use the reordering scheme of FIGS. 8, 9 or 10).

### Coalescing With Global Reorder Buffer

In an embodiment, when using the reordering scheme of FIG. 8, no additional measures are needed for supporting coalescing. Reorder buffer 168 is used for buffering individual fragments, as opposed to entire TLPs.

### Coalescing With Reorder Buffer Per Transaction Type

When using the reordering scheme of FIG. 9 (using a separate reorder buffer per PCIe transaction type), destination-side TEP 48A should be notified of the type (posted, non-posted or completion) of each TLP conveyed in a coalesced PCTP packet. The destination-side TEP needs this information to push the TLPs into the correct buffers 172.

In some embodiments, source-side TEP 48B coalesces together only TLPs of a given type. In other words, a given coalesced PCTP packet contains only TLPs of one type (posted, non-posted or completion). The source-side TEP specifies the type in the PCTP header of the packet.

In other embodiments, source-side TEP 48B permits mixing TLPs of different types in a coalesced PCTP packet. In an embodiment, the source-side TEP specifies the types and PSNs of the various TLPs (or TLP fragments) in the PCTP header of the packet. In another embodiment, each TLP/fragment includes its respective information, e.g., type. In yet another embodiment, the source-side TEP specifies the types of the various TLPs/fragments in the PCTP header of the packet, but with only a single PSN. The single PSN corresponds to the first TLP in the packet, and the PSNs of the other TLPs are implicitly assumed to follow the first PSN sequentially.

### Coalescing With Reorder Buffer per Transaction Type, and Explicit Declarations of Dependency in TLPs

In yet another embodiment, when using the reordering scheme of FIG. 10 (using a separate reorder buffer per PCIe transaction type, and using TLPs that specify explicit dependencies), coalescing may be implemented as follows:
Source-side TEP 48B specifies the types and PSNs of the various TLPs/fragments in the PCTP header of the coalesced PCTP packet.
The PSNs in the dependency declarations specified in the buffered fragments are the PSNs of the last fragments of the dependent TLPs.
The condition for popping a given fragment from buffers 172 now requires that (i) PCIe ordering rules are met, (ii) all previous sequence numbers specified in the explicit dependency declaration in the given fragment have arrived at the destination-side TEP, and (iii) all other fragments of the given fragment's TLP have also arrived at the destination-side TEP.

### TEP Discovery, Initialization and Management

In some embodiments, disaggregation controller 40 carries out suitable processes for discovering hosts 24

that require networking resources, discovering NICs 28 that are available for disaggregation, and establishing, initializing and managing PCIe tunnels 44 between {host, NIC} pairs. Typically, controller 40 holds a suitable database of relevant information, e.g., disaggregated NICs and their properties, hosts that use disaggregation and their properties, identities of the various tunnels 44 and TEPs 48, etc.

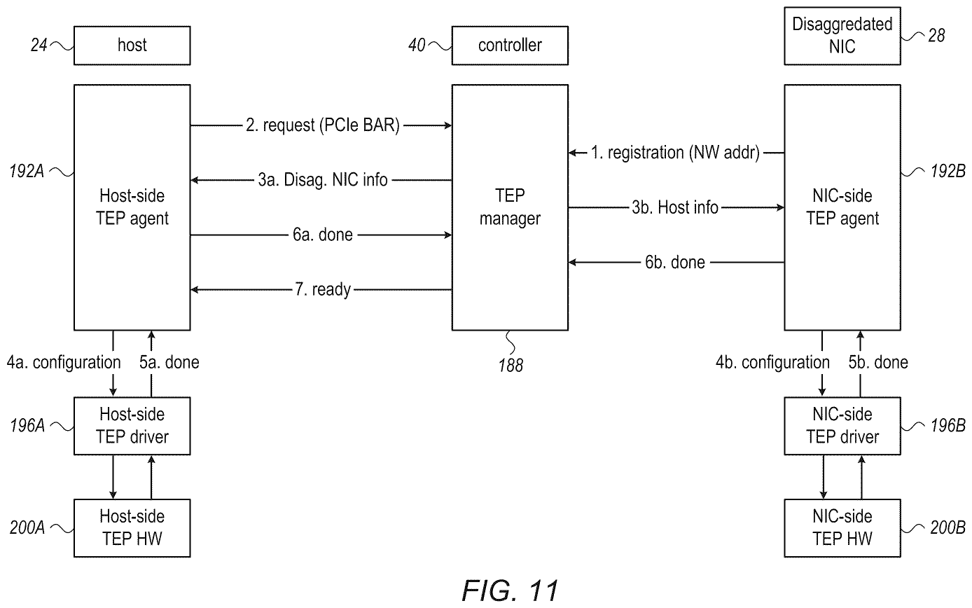

FIG. 11 is a diagram that schematically illustrates an example process of establishing a PCIe tunnel 44 between a certain host 24 and a certain NIC 28, in accordance with an embodiment that is described herein. In the present example, controller 40 runs software referred to as a TEP manager 188. Among other tasks, TEP manager 188 establishes new PCIe tunnels 44.

Host 24 runs a host-side TEP agent 192A that communicates with the host-side TEP 48. The host-side TEP comprises software referred to as a host-side TEP driver 196A, and host-side TEP hardware 200A. NIC 28 runs a NIC-side TEP agent 192B that communicates with the NIC-side TEP 48. The NIC-side TEP comprises software referred to as a NIC-side TEP driver 196B, and NIC-side TEP hardware 200B.

In some embodiments, agents 192 and drivers 196 may run on one or more processing devices that host the disaggregated NIC, or on an embedded processor (“DPU”). In other embodiments, agents 192 and drivers 196 may run on one or more processing devices adjacent to the CTEP, or embedded in the CTEP.

When a NIC 28 that is available for disaggregation joins the system, the new NIC 28 registers with TEP manager 188 of controller 40 (arrow marked “1” in the figure). Registration may be performed over any suitable network, e.g., over an external network using a separate network interface, over fabric 32, or over the same network to which NICs 28 connect hosts 24. In an embodiment, registration is performed on behalf of NIC 28 by some network administration tool.

When a host 24 requires the services of a disaggregated NIC 28, the host sends a request to TEP manager 188 of controller 40 (arrow marked “2” in the figure). Alternatively, the request may be sent on behalf of the host by some network administration tool. This request typically comprises information such as the available PCIe BAR address and a requestor ID. Alternatively, this information may be queried in a separate transaction.

TEP manager 188 typically updates its database in response to each registering NIC, and in response to each requesting host.

To establish a new PCIe tunnel 44 between a certain host 24 and a certain NIC 28, TEP manager 188 sends configuration details to host-side TEP agent 192A and to NIC-side TEP agent 192B (arrows marked “3a” and “3b”, respectively). TEP manager 188 typically notifies host-side TEP agent 192A of the details of the NIC, and notifies NIC-side TEP agent 192B of the details of the host.

Host-side TEP agent 192A configures host-side TEP driver 196A with the configuration details provided by TEP manager 188 (arrow marked “4a”). Similarly, NIC-side TEP agent 192B configures NIC-side TEP driver 196B with the configuration details provided by TEP manager 188 (arrow marked “4b”).

Following successful configuration, host-side TEP driver 196A sends a “done” response (arrow marked “5a”) to host-side TEP agent 192A. Host-side TEP agent 192A forwards the “done” response to TEP manager 188 (arrow marked “6a”). Similarly, NIC-side TEP driver 196B sends a “done” response (arrow marked “5b”) to NIC-side TEP agent 192B. NIC-side TEP agent 192B forwards the “done” response to TEP manager 188 (arrow marked “6b”).

After receiving the two “done” responses, TEP manager 188 sends a “ready” message (arrow marked “7”) to host 24, informing the host that it may begin communication with the disaggregated NIC.

In some embodiments, the database of TEP manager 188 tracks which host 24 is connected to which disaggregated NIC 28. TEP manager 188 may employ various strategies for pairing NICs with hosts. For example, TEP manager 188 may attempt to fill a single NIC 28 with multiple tunnels 44 before progressing to the next NIC. An alternative strategy would prefer a NIC that does not yet have a tunnel, i.e., choose the least loaded NIC for the next tunnel to be established. Further alternatively, any other suitable strategy can be used.

In an embodiment, as part of tunnel establishment, TEP manager 188 may be informed as to the bandwidth requirements of the host. Additionally, or alternatively, TEP manager 188 may gather runtime information such as the amount of bandwidth being used by the host. This information can be used to track the utilization of the various disaggregated NICs, for the sake of managing existing tunnels 44 and establishing new tunnels.

### Example System Use-Case

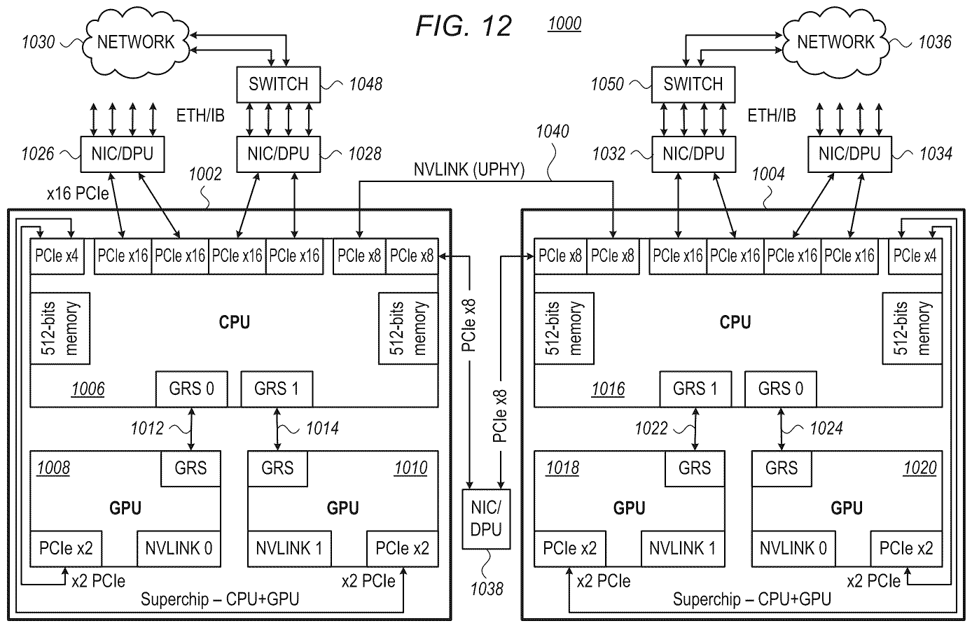

FIG. 12 is a block diagram that schematically illustrates a computing system 1000, e.g., a data center or a High-Performance Computing (HPC) cluster, which uses network device disaggregation, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 12 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 12, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 12, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

In various embodiments, any of the NICs/DPUs of system 1000 may be disaggregated in accordance with the techniques described herein, and any of the processing devices of system 1000 may use disaggregated NICs/DPUs in accordance with the disclosed techniques. The packet switches in FIG. 12 may comprise, for example, Nvidia Quantum-2 switches. The NICs/DPUs in the figure may comprise, for example, Nvidia Bluefield DPUs.

Although the embodiments described herein mainly address disaggregation of peripheral devices, the methods and systems described herein can also be used in other applications, such as in disaggregation of memory or cache, e.g., using protocols such as CXL.cache or CXL.mem.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
one or more processing devices;
one or more peripheral devices; and
an interconnection fabric, to connect the one or more processing devices and the one or more peripheral devices,
wherein a plurality of pairs is set-up in the system, each pair comprising (i) a respective processing device among the one or more processing devices and (ii) a respective peripheral device among the one or more peripheral devices, each pair to communicate over a respective tunnel established via the interconnection fabric, so as to provide resources of the peripheral device to the processing device.

2. The system according to claim 1, wherein, in a given pair, the peripheral device comprises a network device, and the tunnel is established to provide networking resources of the network device to the processing device.

3. The system according to claim 1, wherein, in a given pair, the peripheral device comprises a storage device, and the tunnel is established to provide storage resources of the storage device to the processing device.

4. The system according to claim 1, further comprising a controller to set-up the pairs and the tunnels.

5. The system according to claim 1, wherein the pairs comprise at least (i) a first pair comprising a given processing device and a first peripheral device, and (ii) a second pair comprising the given processing device and a second peripheral device.

6. The system according to claim 1, wherein the pairs comprise at least (i) a first pair comprising a given peripheral device and a first processing device, and (ii) a second pair comprising the given peripheral device and a second processing device.

7. The system according to claim 1, wherein the interconnection fabric operates in accordance with a fabric communication protocol that does not guarantee in-order delivery of data.

8. The system according to claim 1, wherein, for a given tunnel, the processing device and the peripheral device are provisioned with respective tunnel endpoint modules that (i) emulate a local peripheral bus protocol toward the processing device and the peripheral device, and (ii) communicate with one another over the interconnection fabric in accordance with a fabric communication protocol.

9. The system according to claim 8, wherein a tunnel endpoint module is to:
receive packets of the peripheral bus protocol for transporting via the given tunnel;
encapsulate the packets of the peripheral bus protocol at least with network headers of the fabric communication protocol; and
send the encapsulated packets via the given tunnel.

10. The system according to claim 9, wherein the packets of the peripheral bus protocol specify a destination address or destination identifier, and wherein the tunnel endpoint module is to obtain a network address or network identifier associated with the destination address or destination identifier, and to insert the network address or network identifier in the network headers of the encapsulated packets.

11. The system according to claim 8, wherein a tunnel endpoint module is to:
receive, from the given tunnel, encapsulated packets of the fabric communication protocol that contain packets of the peripheral bus protocol;
decapsulate the encapsulated packets to reproduce the packets of the peripheral bus protocol; and
output the packets of the peripheral bus protocol.

12. The system according to claim 8, wherein the tunnel endpoint modules are to implement end-to-end credit-based flow control with one another over the given tunnel.

13. The system according to claim 12, wherein the peripheral bus protocol supports multiple transaction types, and wherein the tunnel endpoint modules are to implement the end-to-end credit-based flow control independently for each of the transaction types of the peripheral bus protocol.

14. The system according to claim 8, wherein the peripheral bus protocol specifies one or more transaction ordering rules that govern an order of delivery of transactions, and wherein the tunnel endpoint modules are to deliver the transactions of the peripheral bus protocol while complying with the transaction ordering rules.

15. The system according to claim 8, wherein:
one of the tunnel endpoint modules is to distribute packets of the fabric communication protocol over multiple different paths via the interconnection fabric; and
the other of the endpoint modules is to receive the packets from the multiple different paths, and reorder the received packets.

16. The system according to claim 8, wherein:
one of the tunnel endpoint modules is to receive a packet of the peripheral bus protocol for transporting via the given tunnel, to fragment the packet into multiple packets of the fabric communication protocol, and to send the packets of the fabric communication protocol via the given tunnel; and
the other of the endpoint modules is to receive the packets from the given tunnel, and reassemble the packet of the peripheral bus protocol from the multiple packets of the fabric communication protocol.

17. The system according to claim 8, wherein:
one of the tunnel endpoint modules is to receive multiple packets of the peripheral bus protocol for transporting via the given tunnel, to coalesce the packets into a packet of the fabric communication protocol, and to send the packet of the fabric communication protocol via the given tunnel; and
the other of the endpoint modules is to receive the coalesced packet from the given tunnel, and re-fragment the coalesced into the multiple packets of the peripheral bus protocol.

18. A method, comprising:
in a system comprising one or more processing devices and one or more peripheral devices connected by an interconnection fabric, setting-up a plurality of pairs, each pair comprising (i) a respective processing device among the one or more processing devices and (ii) a respective peripheral device among the one or more peripheral devices; and
for each pair, providing resources of the respective peripheral device to the respective processing device by communicating over a respective tunnel established via the interconnection fabric.

19. The method according to claim 18, wherein, in a given pair, the peripheral device comprises a network device, and the tunnel is established to provide networking resources of the network device to the processing device.

20. The method according to claim 18, wherein, in a given pair, the peripheral device comprises a storage device, and the tunnel is established to provide storage resources of the storage device to the processing device.
